(19) United States
(12) Patent Application Publication
(10) Pub. No.: US 2021/0401203 A1
(43) Pub. Date: Dec. 30, 2021

(54) Condiment Dispensing Utensil Assembly

(71) Applicant: Michael Garofalo, Brooklyn, NY (US)

(72) Inventor: Michael Garofalo, Brooklyn, NY (US)

(21) Appl. No.: 16/916,675

(22) Filed: Jun. 30, 2020

(51) Int. Cl. A47G 21/00; A47G 21/04; A47G 21/02; B26B 3/02

(52) U.S. Cl. CPC A47G 21/004; B26B 3/02; A47G 21/023; A47G 21/04

(57) ABSTRACT

A condiment dispensing utensil assembly for on-demand dispensing of a condiment includes a utensil, which comprises a shank that can be grasped in a hand of a user. A panel is engaged to the shank and defines a chamber. A condiment is positioned in the chamber and is selectively dispensable therefrom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to utensil assemblies and more particularly pertains to a new utensil assembly for on-demand dispensing of a condiment.

### (2) Description of Related Art Including Information Disclosed Under 37 CFR 1.97 and 1.98

The prior art relates to utensil assemblies. Prior art utensil assemblies having a condiment dispensing function may comprise a utensil having a chamber positioned in a shank thereof, with the chamber housing a condiment that can be selectively dispensed by a user.

### BRIEF SUMMARY OF THE INVENTION

An embodiment of the disclosure meets the needs presented above by generally comprising a utensil, which comprises a shank that is configured to be grasped in a hand of a user. A panel is engaged to the shank and defines a chamber. A condiment is positioned in the chamber and is selectively dispensable therefrom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a condiment dispensing utensil assembly according to an embodiment of the disclosure.

FIG. 2 is a top view of an embodiment of the disclosure.

FIG. 3 is a bottom view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

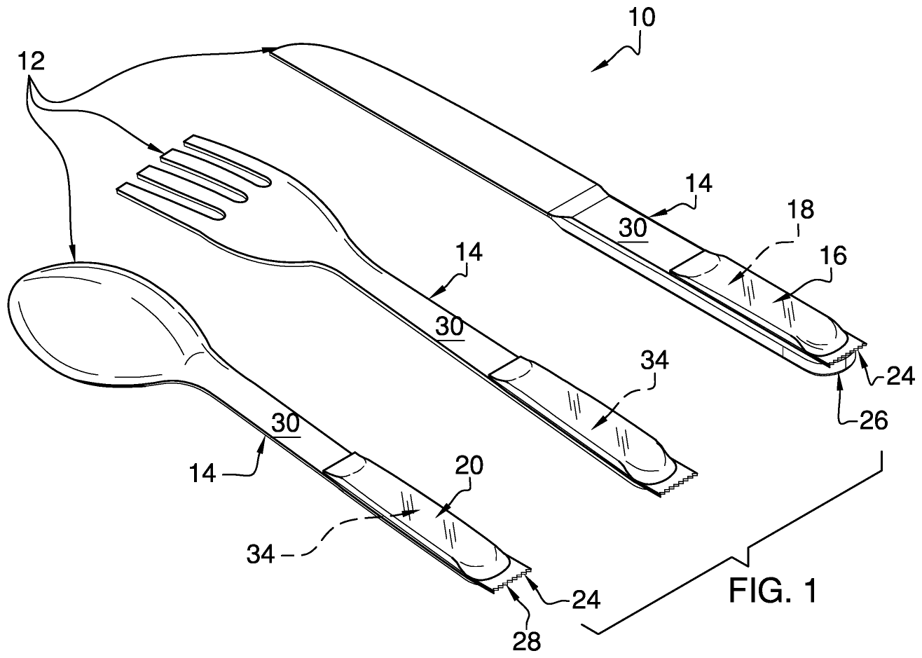

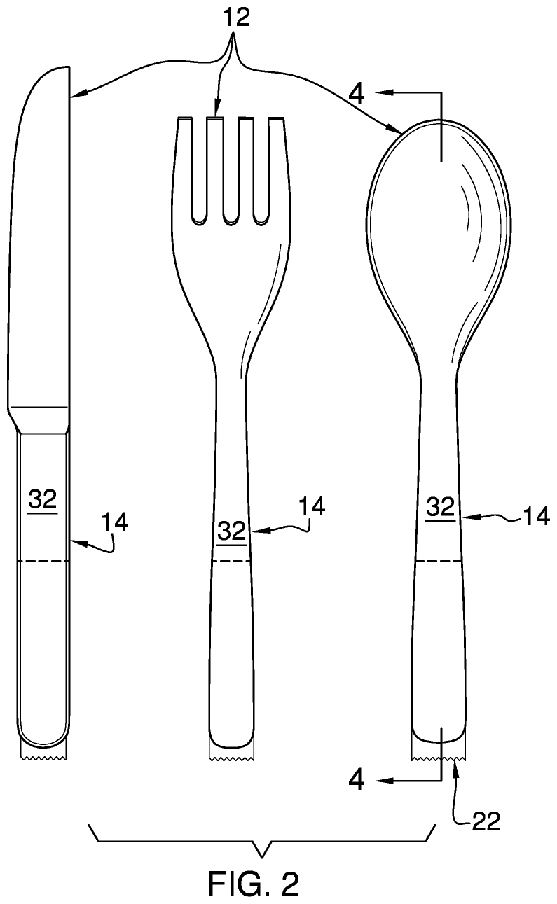

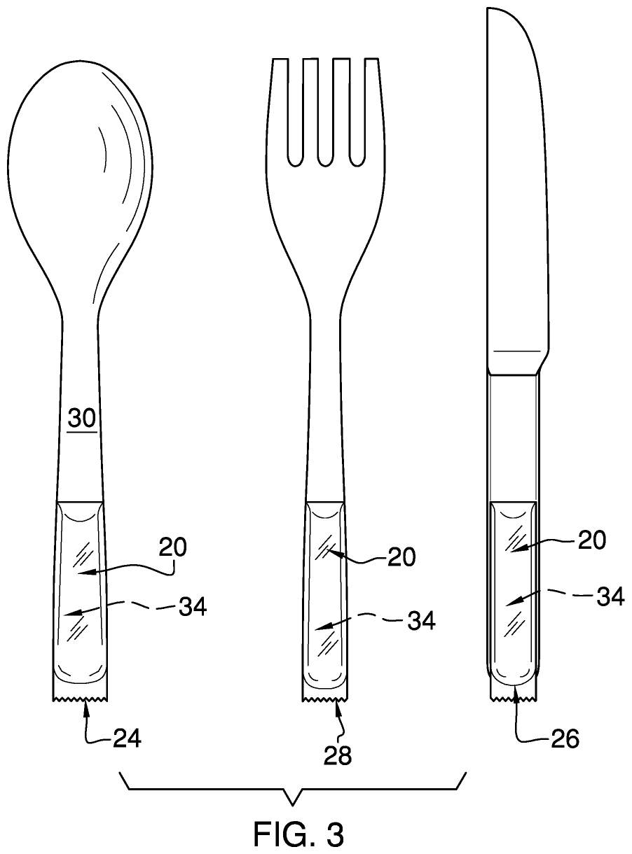

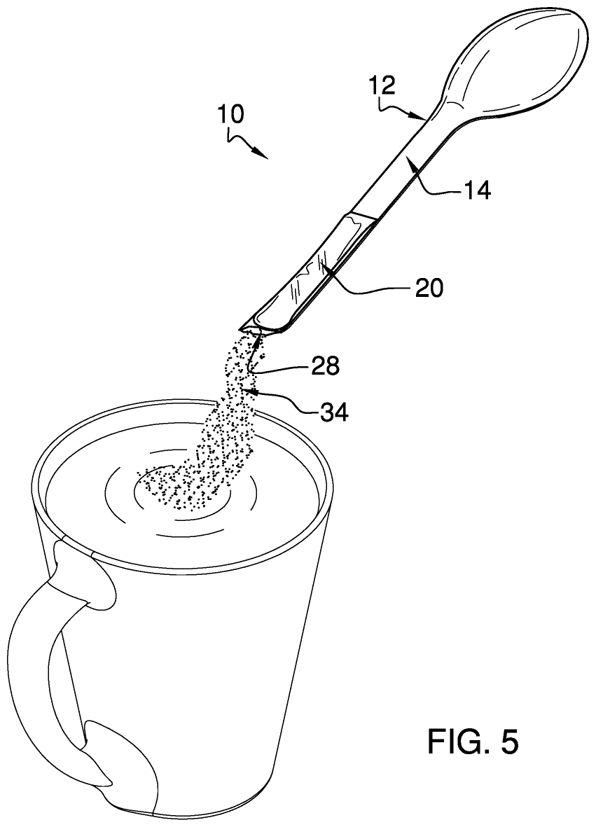

With reference now to the drawings, and in particular to FIGS. 1 through 5 thereof, a new utensil assembly embodying the principles and concepts of an embodiment of the disclosure and generally designated by the reference numeral 10 will be described.

As best illustrated in FIGS. 1 through 5, the condiment dispensing utensil assembly 10 generally comprises a utensil 12. The utensil 12 comprises a shank 14 that is configured to be grasped in a hand of a user. The utensil 12 may comprise plastic, so as to be disposable. The present invention also anticipates the utensil 12 comprising other materials, such as, but not limited to bamboo, wood, and the like.

A panel 16 is engaged to the shank 14 and defines a chamber 18. The panel 16 may comprise a packet 20, which has a first face 22 that is engaged to the shank 14. The packet 20 has a first end 24 extending past a terminus 26 of the shank 14. The packet 20 thus is configured to be torn sidewise proximate to the first end 24.

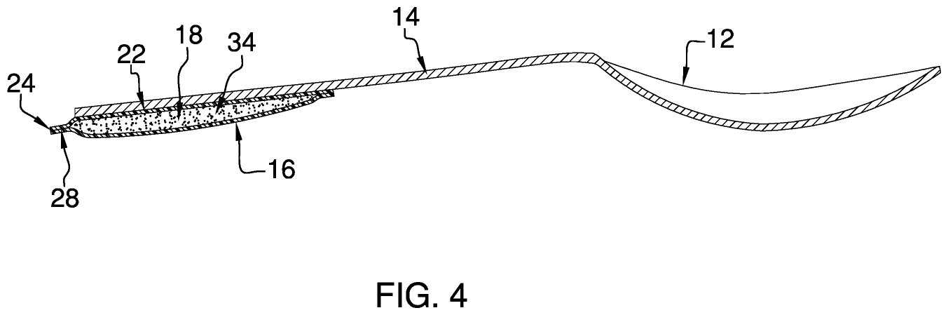

The first end 24 also may have a seam 28 positioned therein, as shown in FIG. 4. The seam 28 is selectively separable by application of pressure to the packet 20. The packet 20 may be positioned on a lower face 30 of the shank 14, as shown in FIG. 1. The present invention also anticipates the packet 20 being positioned on an upper face 32 of the shank 14 (not shown).

A condiment 34 is positioned in the chamber 18 and is selectively dispensable therefrom. The condiment 34 comprises one of a powder, a granulated substrate, or a liquid. A condiment 34 in powder or granulated form would be positioned in a packet 20 that is configured to be torn sideways proximate to the first end 24. A condiment 34 in liquid form would be positioned in a packet 20 wherein the seam 28 is configured to be separated upon application of pressure to the packet 20.

The utensil 12 may be one of a set of utensils 12. Each utensil 12 of the set of utensils 12 has a respective function so that the set of utensils 12 comprises utensils 12 having a variety of functions. The set of utensils 12 may comprise a spoon, a fork, and a knife, as shown in FIG. 1. The present invention also anticipates the set of utensils 12 comprising other utensils 12, such as, but not limited to, chop sticks, sporks, and the like.

The condiment 34 is one of a set of condiments 34, such as, but not limited to, salt, black pepper, red pepper, creamer, sweetener, and the like. Each condiment 34 of the set of condiments 34 is positioned in a respective chamber 18 of an associated utensil 12 of the set of utensils 12.

In use, the utensils 12 of the set of utensils 12 are utilized as for standard cutlery. Should a condiment 34 be desired, it can be dispensed from the packet 20 as required.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A condiment dispensing utensil assembly comprising:
a utensil comprising a shank configured for grasping in a hand of a user;
a panel engaged to the shank such that the panel defines a chamber; and
a condiment positioned in the chamber and being selectively dispensable therefrom.

2. The condiment dispensing utensil assembly of claim 1, wherein the utensil comprises plastic.

3. The condiment dispensing utensil assembly of claim 1, wherein the panel comprises a packet having a first face engaged to the shank.

4. The condiment dispensing utensil assembly of claim 3, wherein the packet has a first end extending past a terminus of the shank, wherein the packet is configured for being torn sidewise proximate to the first end.

5. The condiment dispensing utensil assembly of claim 3, wherein the packet has a first end extending past a terminus of the shank, the first end having a seam positioned therein, the seam being selectively separable by application of pressure to the packet.

6. The condiment dispensing utensil assembly of claim 3, wherein the packet is positioned on a lower face of the shank.

7. The condiment dispensing utensil assembly of claim 1, wherein the condiment comprises one of a powder, a granulated substrate, or a liquid.

8. The condiment dispensing utensil assembly of claim 1, further including the utensil being one of a set of utensils, each utensil of the set of utensils having a respective function, such that the set of utensils comprises utensils having a variety of functions.

9. The condiment dispensing utensil assembly of claim 8, wherein the set of utensils comprises a spoon, a fork, and a knife.

10. The condiment dispensing utensil assembly of claim 8, further including the condiment being one of a set of condiments, each condiment of the set of condiments being positioned in a respective chamber of an associated utensil of the set of utensils.

11. A condiment dispensing utensil assembly comprising:
a utensil comprising a shank configured for grasping in a hand of a user, the utensil comprising plastic;
a panel engaged to the shank such that the panel defines a chamber, the panel comprising a packet having a first face engaged to the shank, the packet having a first end extending past a terminus of the shank, wherein the packet is configured for being torn sidewise proximate to the first end, the first end having a seam positioned therein, the seam being selectively separable by application of pressure to the packet, the packet being positioned on a lower face of the shank;
a condiment positioned in the chamber and being selectively dispensable therefrom, the condiment comprising one of a powder, a granulated substrate, or a liquid;
the utensil being one of a set of utensils, each utensil of the set of utensils having a respective function, such that the set of utensils comprises utensils having a variety of functions, the set of utensils comprising a spoon, a fork, and a knife; and
the condiment being one of a set of condiments, each condiment of the set of condiments being positioned in a respective chamber of an associated utensil of the set of utensils.
